(19) United States
(12) Patent Application Publication
(10) Pub. No.: US 2012/0298878 A1
(43) Pub. Date: Nov. 29, 2012

(54) Delayed Choice Method with Haunted Quantum Entanglement for Choosing at a Distance an Overall Distribution Exhibiting Either Which-Way Information or Interference

(76) Inventor: Douglas Michael Snyder, Los Angeles, CA (US)

(21) Appl. No.: 13/466,326

(22) Filed: May 8, 2012

Related U.S. Application Data
(60) Provisional application No. 61/519,549, filed on May 25, 2011.

(51) Int. Cl. G01T 3/00

(52) U.S. Cl. 250/391

(57) ABSTRACT

Haunted quantum entanglement involves entanglement between two entities where entanglement is based on one particle (1) supplying which-way information to the other particle (2). This entanglement is lost when the entities are spatially separated before 2 is detected and before which-way information for 1 becomes available to the environment or an irreversible which-way measurement is made on 1. The loss of entanglement in haunted quantum entanglement is accompanied by the loss of which-way information supplied by 1 to 2. If the haunted quantum entanglement scenario is repeated, one obtains an overall distribution of 2 exhibiting interference. The entanglement is lost by injecting many particles of a similar character to 1 into the container/s in which 1 could be located. If the entanglement is not lost, one obtains instead an overall which-way information distribution. Whether or not 1 is lost through the injection of other particles is a delayed choice.

### CROSS-REFERENCE TO RELATED APPLICATIONS

This application claims the benefit of provisional patent application Ser. U.S. 61/519,549 filed May 25, 2011 by the present inventor.

### STATEMENT REGARDING FEDERALLY SPONSORED RESEARCH OR DEVELOPMENT

Not Applicable

### REFERENCE TO SEQUENCE LISTING A TABLE, OR A COMPUTER PROGRAM LISTING COMPACT DISK APPENDIX

Not Applicable

### BACKGROUND OF THE INVENTION

The field of endeavor to which the invention pertains is physics.

No relevant patents found.

Following is a description of information known to me that is related to my invention. Also, this description references specific problems involved in the prior art (and accompanying technology) to which my invention is drawn.

D. Greenberger and A. YaSin (Foundations of Physics, vol. 19, no. 6, 1989, ps. 678-704) described a haunted measurement that involved a neutron interferometer with an isolated flexible mirror apparatus along one arm of the interferometer (FIG. 2). While the neutron passes through the flexible mirror apparatus, there is which-way information regarding the path of the neutron. The which-way information is produced by the change in momentum and position of the flexible mirror apparatus that results from its interaction with the neutron. After the neutron exits the flexible mirror apparatus, all which-way information is eliminated and interference is restored as if the which-way information never existed. The original momentum and position of the flexible mirror apparatus are restored. Relevant equations for a haunted quantum measurement are found near the end of “Brief Summary of the Invention”. Which-way information concerning the neutron is eliminated by a direct, local interaction between the neutron and the flexible mirror apparatus. In the invention, which-way information concerning an entity like the neutron is eliminated at a distance from this entity.

M. Scully, B. Englert, and H. Walther (Nature, vol. 351, ps. 111-116, 1991) described a quantum eraser (FIG. 3) wherein an atom enters the micromaser cavity system and emits a photon into one of the two cavities. The cavities have no other photons in them, and they are tuned to the same frequency. The cavities are separated by shutters. Between the shutters is a photodetector. The atom exits the cavity system, passes through the double slit, and passes on to the detection screen. Sometime after exiting the cavity system, the shutters on the micromaser cavities are opened and the photodetector is exposed. There is a 50-50 chance the photon will be detected at the photodetector. Whether or not the photon is detected at the photodetector, which-way information is lost. The result is fringes and anti-fringes when atom detection data and photodetection data are correlated. The overall distribution of the atoms is still the one wide hump characteristic of which-way information (which is the sum of the fringes and anti-fringes). In the invention, the overall distribution of the atoms, or entities like the atoms, changes from what would be a which-way distribution to a distribution exhibiting interference. No correlations are required to obtain this overall distribution exhibiting interference.

The authors of the articles on the haunted measurement and the quantum eraser acknowledged similarities in their work. Both the haunted measurement and the quantum eraser create which-way information through entanglement and which-way information is subsequently eliminated. There is a difference between the haunted measurement and the quantum eraser: In the haunted measurement, an overall distribution exhibiting interference is restored as if the which-way information never existed. In the quantum eraser, there are fringes and anti-fringes that sum to an overall one wide hump indicative of which-way information. A second difference is the following. The restoration of interference occurs because of a local interaction in the haunted measurement. In the quantum eraser fringes and anti-fringes (not overall distributions) can be developed as a result of a distant interaction. In the invention, there is a change to an overall distribution exhibiting interference from what would have been an overall which-way distribution where this change occurs through a distant interaction.

What is the basis for the difference in the distribution patterns in the haunted measurement and the quantum eraser? In a haunted measurement, the entanglement is lost before any measurement information becomes available in the environment. In the Greenberger and YaSin scenario, the flexible mirror apparatus is effectively isolated. In the quantum eraser, the entanglement is maintained.

I suspect the entanglement is maintained in large part due to the availability of information in the environment that a which-way measurement has occurred with the passage of the atom through the double slit. The interiors of the micromaser cavities themselves are isolated, and thus which specific path the atom took from one of the cavities to one of the slits in the double slit is not available in the environment. With the opening of the shutters between the micromaser cavities, information regarding in which specific micromaser cavity the photon was emitted is lost. Information that a which-way measurement has occurred is preserved due to the earlier availability of this information in the environment. Relevant equations for a quantum eraser are found at the end of “Brief Summary of the Invention”.

At end of the quantum eraser paper by Scully, Englert, and Walther, the authors present a scenario like the quantum eraser but in which the atom carries the which-way information, not the photon (FIG. 4). There is a single wall separating the micromaser cavities. The micromaser cavities are filled with classical microwave radiation, and the photon that the atom emits is lost in this radiation. It is not known into which cavity the photon was emitted. The atom itself carries which-way information because the micromaser cavities are tuned to different frequencies. At one exit of the micromaser cavity system, an rf coil is placed so that if the atom passed through the cavity associated with that exit, the atom is placed in the same state it would be in if it had exited the other cavity. The resulting distribution for the atoms is an interference pattern like Greenberger and Yasin's, as if the which-way information had never existed. This distribution exhibiting interference is obtained by losing the which-way information carried by the atoms themselves. In one implementation to be presented of the Delayed Choice Method with Haunted Quantum Entanglement for Choosing at a Distance an Overall Distribution Exhibiting Either Which-Way Information or Interference, the which-way information concerning the atoms is lost at a distance from the atoms.

Y. Kim, R. Yu, S. P. Kulik, Y. Shih, and M. Scully (Phys. Rev. Lett., 84, 1-5, 1999) performed another form of the quantum eraser experiment that incorporated the same fundamentals as those discussed above for the experiment by Scully and his colleagues (FIG. 5). Kim and his colleagues used a device that could act as an interferometer with two possible separate photon-pair sources.

The entangled signal-idler photon pairs were produced by Kim and his colleagues at one of two possible locations (like one slit in a two slit screen). The entanglement incorporated the idler photon's originally providing which-way information concerning the path of the signal photon that manifested itself in the form of the overall distribution of the signal photons at their detection axis. Due to the dimensions of the “double-slit” where the signal-idler photon pairs are created, the signal photon itself essentially carried no which-way information as regards its distribution at its detection axis. (That is what allowed the signal photon to exhibit interference in the form of fringes or anti-fringes when detection data for the entangled entities is correlated should which-way information carried by the idler photon be lost.)

Besides functioning as an interferometer, Kim and his colleagues structured their device so that one-half of the idler photons passing through the first part of the device, specifically that part of the device from M to Y or Z, could provide which-way information regarding the specific paths of paired signal photons when correlations between detection events for paired signal and idler photons are made. They accomplished this through the use of beam splitters instead of full-silvered mirrors at Y and Z. In their experiment, ½ of the generated idler photons traveled through the beam splitters at Y and Z instead of being reflected at Y and Z toward beam splitter BS at N.

The signal photon travels away from the interferometer and impacts a detection system that detects the location of this photon along a spatial axis.

With regard to the idler photons traveling through the beam splitters at Y and Z (i.e., BS_Y and BS_Z) and being detected at either detector D3 or detector D4, the two distributions of the detected signal photons correlated with the detections of their paired idler photons each showed the one broad hump characteristic of which-way information. (The two distributions summed to an overall one broad hump as well.)

For the ½ of the generated idler photons that are instead reflected at the beam splitters at Y or Z toward BS at N and that are subsequently detected at either detector D1 or detector D2, the distributions of the signal photons detected at D5 along a spatial axis x correlated with the detections of their paired idler photons are two multiple narrow hump sub-distributions that indicate the presence of interference (i.e., fringes and anti-fringes).

The fringes and anti-fringes sub-distributions for the signal photons sum to the one wide hump characteristic of which-way information. These fringes and anti-fringes indicate the loss of which-way information concerning the specific path through the interferometer of the paired idler photons that are reflected from BS at N. This specific which-way information concerning the path of the idler photon through the interferometer until BS at N stemmed from the origin of the entangled idler and signal photon pairs at one specific location of two possible ones in which the signal-idler photon pair could be generated. These two locations were like the two slits in a double slit experiment used to demonstrate interference.

Even though specific which-way information is lost concerning the path of the idler photon through the interferometer, general which-way information that a which-way measurement occurred appears to be preserved (since the entanglement is preserved) in the overall one wide hump distribution of the signal photons in the signal-idler photon pairs. This overall which-way distribution is the sum of the fringes and anti-fringes that depends on correlations between paired signal and idler photons and that show the loss of which-way information concerning at which “slit” of the two possible “slits” the signal-idler photon pair was created. Those slits are not isolated from the environment and information is thus available when the signal-idler photon pair was created that a which-way measurement had occurred.

As noted, which-way information regarding the distribution of the signal photon at its detection axis is not provided in the Kim experiment by the signal photon itself traveling away from the interferometer and toward the spatial axis where its location is detected. Shortly after the signal-idler photon pair is generated, due to the dimensions of the “double slit,” the component wave functions for the signal photon for the two possible locations where the signal-idler photon pair were created (i.e., the “double slit”) overlap. Essentially, we have a kind of “delayed choice” experiment (J. Wheeler, “The Past and the ‘Delayed-Choice’ Double-Slit Experiment,” in Mathematical Foundations of Quantum Theory, ps. 9-48, [A. Marlow, Ed], Academic Press, 1978; “Law Without Law,” in Quantum Theory and Measurement, ps. 182-213, J. Wheeler and W. Zurek, Eds., Princeton University Press, 1984).

The “delayed choice” in the Kim experiment involves whether or not the idler photon passes through one of the half-silvered mirrors Y or Z (that take the place of full silvered mirrors) and travels to a detector or instead is reflected off one of the half-silvered mirrors, passes through the beam splitter at the intersection of the two possible paths of the idler photon through the interferometer and is then detected. Specific which-way information for the signal photon as regards the “delayed choice” is dependent on specific which-way information for the paired idler photon. The dimensions of the double slit relative to the wavelength of the signal photons supports interference in the distribution of the signal photons at their detection axis in the absence of which-way information provided by the idler photons.

Similar to Scully, Englert, and Walther's experiment, Kim and his colleagues found fringes and anti-fringes when photodetection data for the signal and idler photons (D1, D2, and D5) were correlated. The overall distribution of the signal photons is still the one wide hump characteristic of which-way information (which is the sum of the fringes and anti-fringes). In one implementation to be presented of the Delayed Choice Method with Haunted Quantum Entanglement for Choosing at a Distance an Overall Distribution Exhibiting Either Which-Way Information or Interference, the overall distribution of the signal photons, or entities like the signal photons, changes from what would be a which-way distribution to a distribution exhibiting interference. No correlations are required to obtain this overall distribution exhibiting interference.

### BRIEF SUMMARY OF THE INVENTION

The method of Delayed Choice Method with Haunted Quantum Entanglement for Choosing at a Distance an Overall Distribution Exhibiting Either Which-Way Information or Interference that is the invention is first introduced. Two implementations of the method are then presented that are developed through making significant changes to the quantum eraser experiments described in “Background of the Invention”. Then the steps of the method of Delayed Choice Method with Haunted Quantum Entanglement for Choosing at a Distance an Overall Distribution Exhibiting Either Which-Way Information or Interference are described in greater detail. Finally, relevant equations for haunted quantum entanglement are presented as are relevant equations for the quantum eraser.

The method that is the invention depends on haunted quantum entanglement. Haunted quantum entanglement involves entanglement between two entities where entanglement is based on one particle (1) supplying which-way information to the other particle (2). This entanglement is lost when the entities are spatially separated before particle 2 is detected and before which-way information for particle 1 becomes available to the environment or an irreversible which-way measurement is made on particle 1. The entanglement is lost when the which-way information held by particle 1 is lost (through the essential loss of particle 1 itself) and which-way information for particle 2 can no longer be supplied by particle 1. Losing the quantum entanglement occurs in the loss of which-way information embodied in the entanglement. If this scenario is repeated, one obtains interference in the overall distribution of particle 2 as if which-way information never existed in the distribution of particle 2 that had previously been supplied which-way information by particle 1 with which it had been entangled. (This distribution is not fringes or anti-fringes that require correlation of detection data for the entangled entities as occurs in a quantum eraser where the fringes and anti-fringes sum to an overall which-way distribution.) The entanglement is lost by injecting many particles of a similar character to 1 into the container/s in which 1 could be located. If the entanglement is not lost, one obtains an overall which-way distribution for particle 2 (that is distinct from an overall distribution exhibiting interference) because particle 1 does not stop supplying which-way information to particle 2. Whether or not particle 1 is lost through the injection of other particles is a delayed choice.

In one implementation of Delayed Choice Method with Haunted Quantum Entanglement for Choosing at a Distance an Overall Distribution Exhibiting Either Which-Way Information or Interference, which-way information supplied by photons as concerns the distribution of atoms with which the photons are entangled is eliminated at a distance between the paired atom and photon when the photon is essentially lost in classical microwave radiation before which-way information embodied in the entanglement becomes available in the environment (implementation 1). This implementation occurs in a setup where significant changes are made to the quantum eraser scenario, with the result that one can obtain an overall distribution of the atoms exhibiting interference as if the which-way information carried by the photon and supplied to the atom never existed.

To accomplish this task, the quantum eraser scenario is changed so that the entanglement of paired particles is lost before any which-way information concerning the entangled paired particles is made available in the environment. The which-way information carried by only one of the entangled particles in the pair is lost when this particle is itself lost, this particle that had carried this which-way information can no longer supply which-way information to the other particle in the pair with which it is entangled, and the entanglement of the paired particles is lost.

Scully, Englert, and Walther's quantum eraser setup involving the emitting atom and the emitted photon is changed significantly in the method that is the invention so that no which-way information of any kind is made available in the environment before the entanglement is lost between the atom and photon. No irreversible measurement is made on the photon before the entanglement is lost which occurs when the photon is essentially lost. Losing the entanglement, through the loss of the which-way information carried by the photon and supplied to the atom, is haunted quantum entanglement.

To accomplish the goal of obtaining interference as if which-way information never existed (i.e., where the photon originally supplied the which-way information to the atom that emitted the photon), a single wall separates the micromaser cavities. There is no photodetector between the cavities as in the quantum eraser setup. Those are two changes to the quantum eraser setup of Scully, Englert, and Walther. In another change, there are reservoirs of classical microwave radiation adjacent to each micromaser cavity. If the classical microwave radiation is not released into the micromaser cavities, the resulting overall distribution of the atoms is the one wide hump characteristic of which-way information (FIG. 6).

Continuing on with the steps needed to accomplish the goal of obtaining interference as if which-way information never existed (i.e., where the photon originally supplied the which-way information to the atom that emitted the photon), the entanglement is eliminated by losing the photon before the atom reaches the double slit. The photon is lost by filling both micromaser cavities with classical microwave radiation after the photon is emitted and the atom exits the cavity system and before the atom reaches the two slit screen (FIG. 7).

In another change from the quantum eraser scenario, any possibility of the atom itself carrying which-way information is eliminated by placing an rf coil that extends a field over both paths, with the field beginning at the exits of the micromaser cavities, that places the atom in the state it had before it emitted the photon.

This is haunted quantum entanglement where interference is obtained as if the which-way information never existed and the photon never carried the which-way information for the atom that is distant from it. The which-way information carried by the photon is eliminated at a distance from the atom with the loss of the entanglement between the atom and the photon. In essence, there is a delayed choice whether to obtain an overall one wide hump distribution characteristic of which-way information or an overall multiple narrow hump distribution characteristic of interference in the distribution of the atoms at a detection screen. Relevant equations for haunted quantum entanglement are found near the end of “Brief Summary of the Invention.”

Greenberger and YaSin demonstrated haunted quantum entanglement in their experiment where they obtained interference as if the which-way information provided by the flexible mirror apparatus had never existed. Which-way information in their haunted measurement, though, is eliminated by a direct interaction between the flexible mirror apparatus and the neutron instead of at a distance between them as occurs in the haunted quantum entanglement scenario presented here.

So far, we have been concerned with photons as well as atoms in our scenarios. The haunted quantum entanglement scenario just presented can be extended to one where we are dealing only with photons. To do so, one can modify the quantum eraser scenario of Kim, Yu, Kulik, Shih, and Scully.

In order to extend haunted quantum entanglement to a scenario where we are dealing only with photons, the apparatus of Kim and his colleagues can be changed as follows (implementation 2) (FIG. 8). The device retains the first legs of the two arms of an interferometer, with two possible photon sources, over which the idler photons can travel. (Call this part of the apparatus the idler apparatus.)

The idler photon moving through the idler apparatus is initially entangled with a second paired photon (the signal photon) where the signal-idler photon pair is initially generated at a single location (one of two possible “slits”). The setup allows the idler photon to travel from its location of origination of the signal-idler photon pair at one “slit” of the “double slit” arrangement, travel along the particular path associated with the “slit” where the particle pair was created, and interact with one of two detectors. One detector is located at each end of one of the two legs of the idler apparatus.

Except for the two idler photon detectors, the idler apparatus (including the “double-slit” arrangement involved in the generation of the signal-idler photon pairs) is placed in a container that prevents information concerning the state of the idler photons from being available in the environment (outside the signal-idler photon system). This container also prevents any interaction between something in the environment (anything outside the processes described here concerning the signal and idler photon pairs) and the idler photon. This container is evacuated except for the idler photon that traverses it. (This container helps to ensure a scenario like that in the first implementation with the emitted photon in the micromaser cavity system where this photon can provide which-way information to the atom that emitted the photon unless the photon is lost.) Another container encompasses the area between the lens that produces the far field effect for the signal photons until just before the signal photons reach the detector axis. This container is also evacuated except for the signal photon that traverses it and provides the same isolation from the environment as does the container for the idler photon.

In other words, the idler photons are isolated until the idler photons exit the idler apparatus container which occurs just before they reach the idler photon detectors. The signal photons themselves are isolated in a container until just before they reach their detection axis. Which-way information concerning the signal photons held by idler photons is made public in detection of idler photons at the idler photon detectors. In this way, isolation of the signal photons is removed at the same time the idler photon isolation is removed because of the entanglement of these photons. The signal and idler photon pathways are set up so that the idler photon is detected before its paired signal photon is detected.

Attached to the container of the idler apparatus are two reservoirs of classical electromagnetic radiation where the component photons are similar in character to the idler photon. Where the reservoirs are closed off from the idler photon apparatus so that none of the classical electromagnetic radiation enters the evacuated idler apparatus, which-way information concerning the idler-signal photon pairs is potentially available as the idler photon traverses one or the other of the paths of the isolated idler apparatus.

This which-path information derives originally from the two possible photon sources in the idler apparatus, each source associated uniquely with one path for the idler photons through the idler apparatus. In this scenario where the idler photon is detected at one of two detectors, the overall signal photon distribution is the one wide hump characteristic of which-way information due to the character of the signal-idler photon entanglement. (Also, even before the idler photons are detected [i.e., while the idler photons are in the process of traversing the idler apparatus], the same distribution of signal photons would be obtained even though a which-way measurement of the idler photon has not been completed by its arrival at one or the other of its detectors.)

If classical electromagnetic radiation from the reservoirs (where the photons comprising this radiation are similar to the idler photon) is injected into the evacuated idler photon container (except of course for the idler photon) while the idler photon is traversing the container and before the signal photon reaches the axis where it is detected, the overall distribution of the signal photons exhibits interference as if which-way information never existed for the signal photons (FIG. 9). This distribution is obtained because the idler photon is effectively lost with the injection of the classical electromagnetic radiation. More specifically, the entanglement between the signal and idler photons is lost in this process and in losing the entanglement the which-way information concerning the signal photon supplied by the idler photon is also lost. With no which-way information for the signal photons supplied by the paired idler photons, the signal photons exhibit interference in their overall distribution as if which-way information never existed (not fringes or anti-fringes that require correlation of detection data for the entangled entities and that sum to an overall which-way distribution pattern as occurs in a quantum eraser). “Two slit” interference for the signal photon shows no evidence that which-way information ever existed regarding the signal photon.

As discussed, the “double slit” setup at which the signal-idler photon pairs are formed supports a kind of “delayed choice” in the Kim experiment where the idler photons are involved in the “delayed choice”. These idler photons provide for either which-way information or instead interference in the distribution of the signal photons (in the form of fringes and anti-fringes that sum to an overall which-way distribution when correlations are made between the paired idler and signal photons). In the invention, the dimensions of the double-slit relative to the wavelength of the signal photon can be the same as in the Kim experiment and allow for the development of an overall distribution exhibiting interference for the signal photons. Thus, in the invention the double slit supports interference in the overall distribution of the signal photons in the invention as if which-way information never existed concerning the signal photons where the paired idler photons are lost through the injection of classical electromagnetic radiation (where the photons comprising this radiation are similar to the idler photon). In the invention, the delayed choice is with regard to the overall distribution of the signal photons, either a which-way distribution or a distribution exhibiting interference. The dimensions of the double slit relative to the wavelength of the signal photons supports interference in the overall distribution of the signal photons at their detection axis in the absence of which-way information provided by the idler photons. The loss of the idler photon results in the loss of the signal-idler photon entanglement. Which-way information in the overall distribution of the signal photons is dependent on the signal-idler photon entanglement through which which-way information is provided by the idler photon to the signal photon.

With the loss of the idler photon in classical electromagnetic radiation in haunted quantum entanglement, the signal photon is not left in a state of just not knowing through which slit the signal photon passed but knowing that it had indeed passed through one specific slit of the two slits. If the signal photon were left is a state of just not knowing through which slit the signal photon passed but knowing that it had indeed passed through one specific slit, the overall distribution of the signal photons would be a which-way distribution and not a distribution exhibiting interference. There would exist which-way information held by the signal photons.

If the case is one of just not knowing the specific path of a particle but also knowing that the particle had indeed passed through one of two possible paths, interference fringes and anti-fringes in the quantum eraser of Kim and his colleagues would not be obtained when correlations are made in the quantum eraser between paired signal and idler photon detections or between atom and emitted photons in the quantum eraser scenario of Scully and his colleagues. The reason is that specific which-way information existed, even if it was not known. Instead one could only obtain which-way distributions for the signal-idler photon pairs when correlations are made in the quantum eraser. In other words, in the quantum eraser we really lose which-way information with the erasure and that is why interference fringes and anti-fringes can be obtained when correlations are made. It is also known that a which-way measurement had taken place and therefore we find that the fringes and anti-fringes (upon correlation) sum to an overall which-way distribution in the quantum eraser. With erasure, the specific path of the signal photon in the Kim experiment or the atom in the Scully scenario can no longer be determined.

The method of Delayed Choice Method with Haunted Quantum Entanglement for Choosing at a Distance an Overall Distribution Exhibiting Either Which-Way Information or Interference follows:
1. Entanglement between two particles 1 and 2 where entanglement occurs at one of two possible sites isolated from the environment. Other than which-way information that characterizes the particle pair itself, there is no tell-tale sign of which-way information that remains after the entanglement occurs.
2. Entangled particles physically separate from each other where one particle's motion [1] preserves which-way information that accompanied entanglement and the other particle's motion [2] supports interference in its own (particle 2's) distribution. The result is that particle 1 supplies which-way information to particle 2. The two particles are effectively isolated from the environment as they move away from one another and until just before they are detected.
3. Delayed choice:
Choice A Essentially lose particle 1 that carries which-way information by injecting many other particles of similar character to particle 1 (that carries which-way information) into a container that heretofore contains only particle 1 and isolates particle 1 from the environment (so that with the injection of many other particles, particle 1 is unrecognizable) while particle 2 is effectively isolated from the environment and before particle 2 is detected or makes available general which-way information held by particle 1 available to the environment. (Particle 1 is essentially lost, particle 1's own which-way information that it supplied to particle 2 is lost, and thus entanglement between particles 1 and 2 that depends on which-way information supplied by particle 1 to particle 2 is also lost.)
Choice B Do not lose particle 1 that carries which-way information. By not losing particle 1 that carries which-way information, the which-way information carried by particle 1 is not lost. The entanglement is not lost since the which-way information supplied by particle 1 to particle 2 is not lost. (Particle 1 could travel to and be detected at a detector that is associated with the specific path of particle 1 that would provide a final result regarding which path particle 1 took.)
3. Depending on Choice A or Choice B:
If Choice A Repeat runs with choice A 100 times consecutively to develop an overall interference distribution pattern for particle 2.
If Choice B Repeat runs with choice B 100 times consecutively to develop an overall which-way distribution pattern for particle 2.
   Regarding the Delayed Choice Method with Haunted Quantum Entanglement for Choosing at a Distance an Overall Distribution Exhibiting Either Which-Way Information or Interference, the following points should be noted:
1) The process of entanglement is isolated and the resulting entangled particles are each isolated in their subsequent motion until the particle carrying the which-way information (particle 1) is: 1) either lost through the injection of many particles into the container with particle 1 that are similar in character to particle 1, with the accompanying loss of the entanglement or 2) there is no injection of many particles of a similar character to particle 1 into the container with particle 1 and particle 1 travels a specific path and can be detected at one of its detectors (either detector 1 or detector 2), providing which-way information to particle 2.
2) Even though each particle originally possesses which-way info, one particle (particle 2) cannot access its own which-way info after entanglement due to the device setup (i.e., a “two-slit arrangement” with suitable dimensions). After entanglement, the device setup supports interference rather than which-way information for particle 2 (e.g., an entangled pair created at one of two “slits” and then the separation between the two “slits” as well as the width of each slit acts as a double slit setup for particle 2 with the result that one obtains interference for particle 2 in the absence of which-way information from particle 1.) The which-way information for particle 2 can come from particle 1 since the which-way information is preserved for particle 1 unless and until the particle carrying the which-way information is lost through the injection of many particles into the container with particle 1 that are similar in character to particle 1. (FIG. 1)

The following text provides background on relevant equations. After entanglement occurs in an isolated environment, the equation for the haunted quantum entanglement would be:

ψ=1/√2[(A_{—}u)|P_{—}u>+(A_{—}l)|P_{—}l>] [1]

where A represents the atom in implementation 1 of the invention and the signal photon in implementation 2 of the invention, and P represents the photon emitted by the atom in implementation 1 of the invention and the idler photon in implementation 2 of the invention. In implementation 1 of the invention, u and l represent the different micromaser cavities and potentially the specific slit associated with each specific cavity. In implementation 2 of the invention, u represents the two paths for the paired signal and idler photons originating at one slit and l represents the two paths for the paired signal and idler photons originating at the other slit. In the general formulation of the haunted quantum entanglement used in the method that is the invention, P represents particle 1 that supplies which-way information to particle 2, A represents particle 2 that loses its own which-way information due to the device setup, u and l represent the two possible entanglement sites for P and A (as well as two possible particle paths, each associated uniquely with specific entanglement sites).

Equation 1 also represents a haunted measurement of Greenberger and YaSin where for example the neutron is interacting with the flexible mirror apparatus (A represents the neutron, P represents the flexible mirror apparatus along one interferometer arm and its imagined equivalent on the other interferometer arm, u represents one arm of the interferometer, and l represents the other arm of the interferometer).

For the haunted quantum entanglement in the method that is the invention as well as the haunted measurement of Greenberger and YaSin, |P_u> and |P_l> then serve as which-way markers in that one obtains:

|ψ|²=1/2[|(A_{—}u)|²<P_{—}u|P_{—}u>+(A_{—}l)|²<P_{—}l|P_{—}l>+(A_{—}u*A_{—}l)<P_{—}u|P_{—}l>+(A_{—}l*A_{—}u)<P_{—}l|P_{—}u>] [2]

or

|ψ|²=1/2|(A_{—}u)|²+1/2|(A_{—}l)² [3]

since

<P_{—}u|P_{—}l>=0 [4]

<P_{—}l|P_{—}u>=0 [5]

In contrast, with elimination of the entanglement between the atom and the emitted photon in implementation 1 of the invention by essentially losing the emitted photon (and its which-way information) in classical electromagnetic radiation before the atom passes through the double slit screen, or the elimination of the entanglement between the paired signal and idler photons in implementation 2 of the invention by essentially losing the idler photon (and its which-way information) in classical electromagnetic radiation composed of photons similar to the idler photon while the system is still essentially isolated and before the signal photon is detected, the appropriate equation for A (the atom in implementation 1 of the invention and the signal photon in implementation 2 of the invention) is now:

ψ=[1/√2[(A_{—}u)+(A_{—}l)]] [6]

and

|ψ|²=1/4[|(A_{—}u)|²+(A_{—}u)*(A_{—}l)+(A_{—}l)*(A_{—}u)+|(A_{—}l)|²]. [7]

Equations 6 and 7 apply to the general formulation of the haunted quantum entanglement used in the method that is the invention. They also apply to Greenberger and YaSin's haunted measurement. Eqn. 7 provides for an overall distribution of A that exhibits interference. P is essentially lost, meaning that in the two implementations of the method that is the invention, the emitted photon in implementation 1 and the idler photon in implementation 2 are essentially lost. Entanglement between A and P is lost as well. P cannot provide which-way information to A since it essentially does not exist as regards A. Eqn. 6 also represents the state of the neutron in Greenberger and YaSin's haunted measurement after the neutron exits the flexible mirror apparatus.

In contrast to haunted quantum entanglement, the entanglement between the emitter atom and emitted photon in the Scully setup or paired signal and idler photons in the Kim setup (both quantum eraser setups) is maintained until detection of the idler photon in the Kim experiment or either the detection of the emitted photon or its non-detection in the case of the Scully setup occurs. The initial equation representing the entanglement has the form of Eqn. 1. The form in which the entanglement is expressed once there is quantum erasure changes to:

ψ=1/√2[(A_{—}s)|P_{—}s>+(A_{—}a)|P_{—}a>] [8]

where (A_s) and |P_s> represent symmetric wave functions and (A_a) and |P_a> represent anti-symmetric wave functions, and

A_{—}u=1/√2[A_{—}s+A_{—}a)], [9]

A_{—}l=1/√2[A_{—}s−A_{—}a], [10]

|P_{—}u>=1/√2[|P_{—}s>+|P_{—}a>], [11]

|P_{—}l>=1/√2[|P_{—}s>−|P_{—}a>]. [12]

In this unitary transformation, entanglement is still maintained and since

<P_{—}s|P_{—}a>=0 [13]

<P_{—}a|P_{—}s>=0 [14]

Taking the absolute square of Eqn. 8 is:

|ψ|²=1/2|(A_{—}s)|²+1/2|(A_{—}a)|² [15]

Thus in the quantum eraser, one maintains the overall one wide hump indicative of which-way information even though one can also obtain fringes and anti-fringes with correlations between the paired particles when there is quantum erasure that sum to the overall one wide hump distribution of the either atoms in the Scully setup or the signal photons in the Kim setup.

The full transformation for the quantum eraser is given by:

ψ=1/√2[(A_{—}u)|P_{—}u>+(A_{—}l)|P_{—}l>] [1]

ψ=1/√2[[[1/√2 [(A_{—}s+A_{—}a)]][[1/√2[|P_{—}s>+|P_{—}a>]]+[[1/√2[(A_{—}s−A_{—}a)]][[1/√2[|P_{—}s>−|P_{—}a>]]] [16]

ψ=1/√2[[[1/√2(A_{—}s)]+++[1/√2(A_{—}a)][1/√2|P_{—}a>]]+[[1/√2(A_{—}s)][1/√2|P_{—}s>]+++[−1/√2(A_{—}a)][−1/√2|P_{—}a]]] [17]

ψ=1/√2[[2[1/√2(A_{—}s)][1/√2|P_{—}s>]]+[2[1/√2(A_{—}a)][1/√2|P_{—}a]]] [18]

ψ=1/√2[(A_{—}s)|P_{—}s>+(A_{—}a)|P_{—}a>] [8]

Relevant formulas for obtaining interference in design of double slit are:

y=(λ)(L)(0.5)/d [19]

where y is the distance to the first interference minimum, λ is the wavelength, L is the distance from the double slit to the detection axis, and d is the distance between the two slits. L is >> than d, and d>>X.

y=L sin (θ) [20]

where y is the distance to the first diffraction minimum, L is the distance from a single slit to the detection axis, and θ is the angle between the central diffraction maximum and the first diffraction minimum. Eqn. 20 is derived for small θ from:

sin (θ)=λ/a [21]

for Fraunhofer diffraction where θ is the angle off the central diffraction maximum, λ is the wavelength, and a is the width of the diffraction slit.

### SEVERAL VIEWS OF THE DRAWING

FIG. 1—Depiction of Delayed Choice Method with Haunted Quantum Entanglement for Choosing at a Distance an Overall Distribution Exhibiting Either Which-Way Information or Interference.

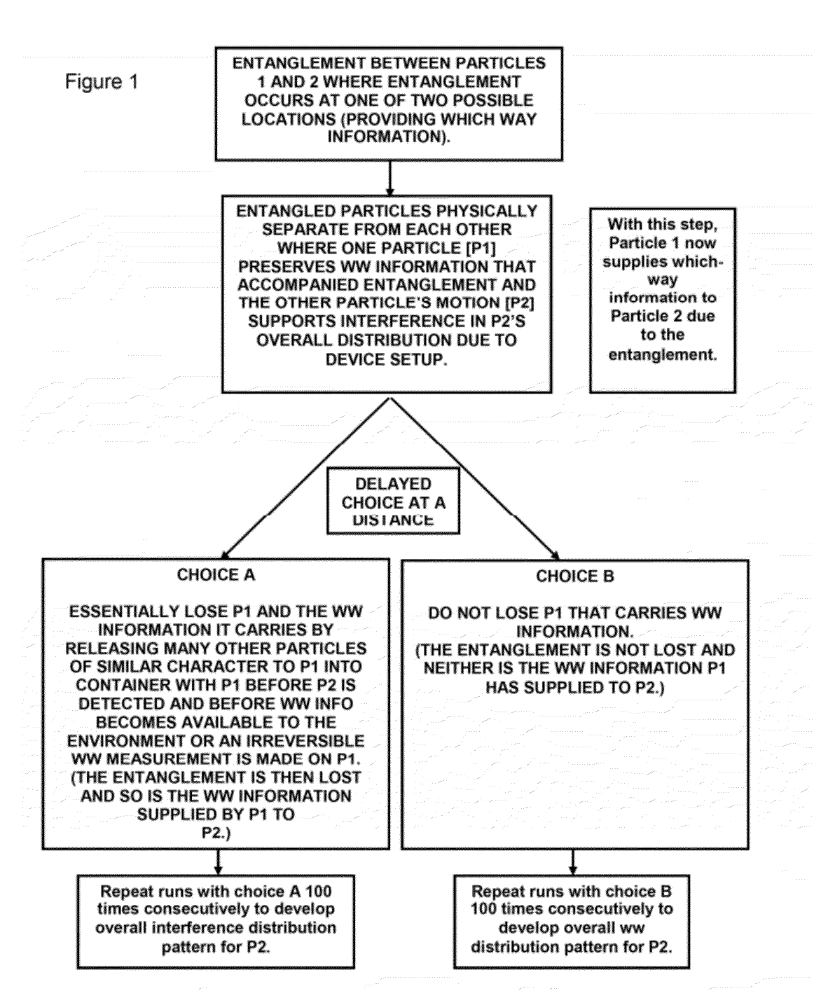

FIG. 2—Greenberger and YaSin's haunted measurement setup with isolated flexible mirror apparatus along one arm of interferometer.

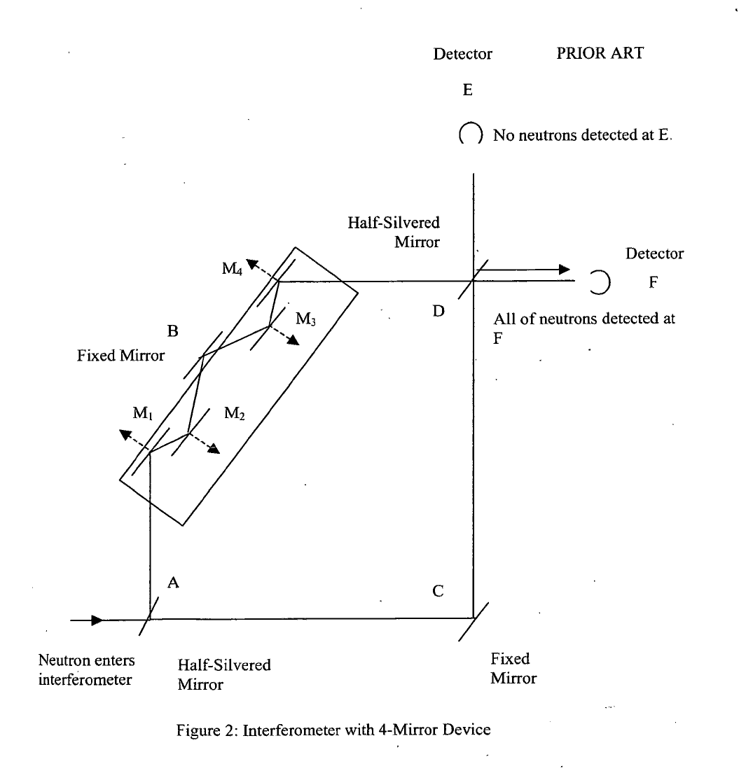

FIG. 3—Overview of basic features of quantum eraser experiment described by Scully and colleagues. There are two shutters, one shutter between one micromaser cavity and the photodetector and one shutter between the other micromaser cavity and the photodetector. Two sub-interference patterns are shown that sum to the one-hump distribution characteristic of which-way information concerning the path of the atoms to the detection screen. The sub-interference patterns depend on correlating: 1) whether the photon that had been located in one of the two micromaser cavities was or was not detected by the photodetector when the shutters were opened and 2) the detection of the atom that had emitted the photon in the micromaser cavity system.

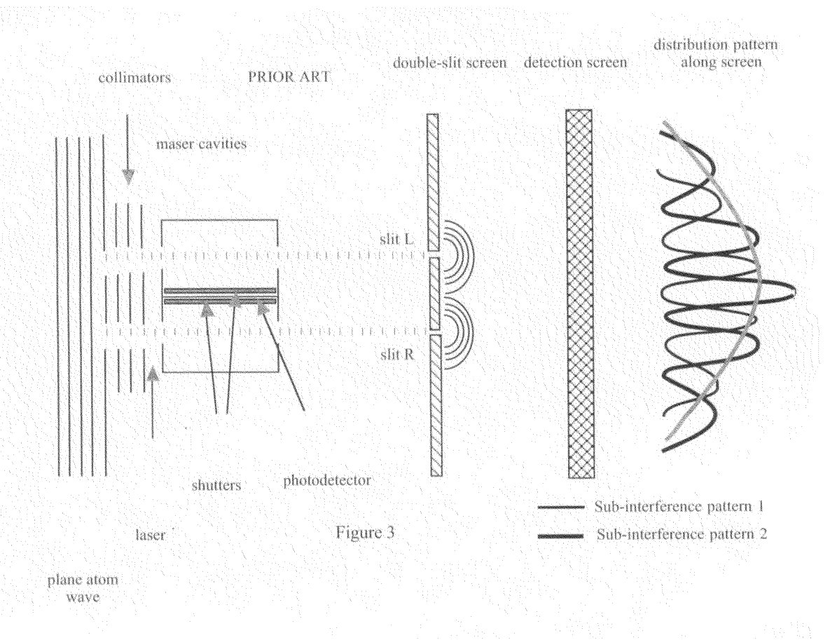

FIG. 4—A scenario like the quantum eraser of Scully, Englert, and Walther's but in which the atom carries the which-way information, not the photon.

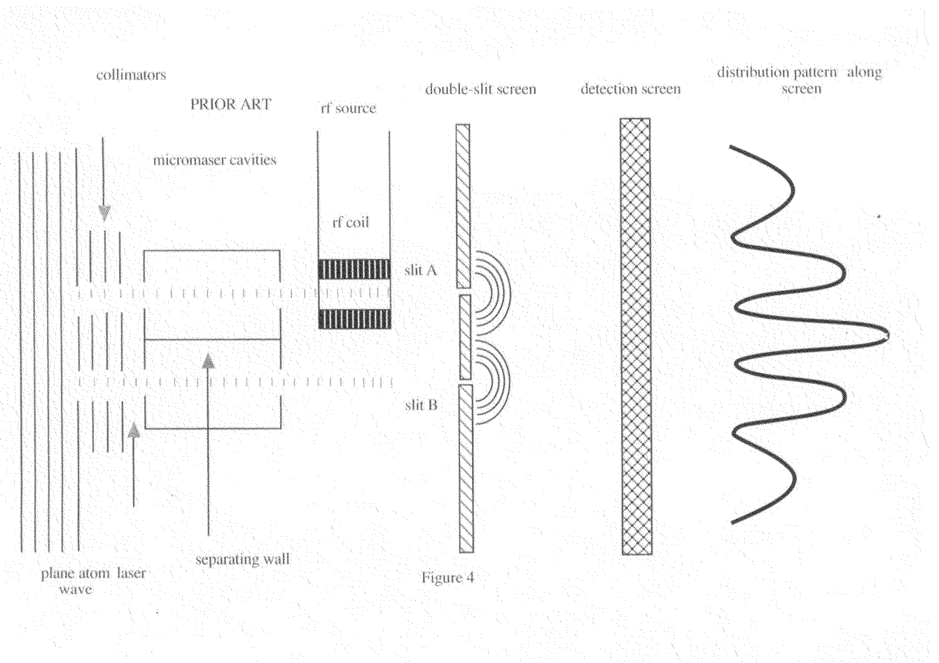

FIG. 5—Schematic of the experiment by Kim and his colleagues involving entangled pairs of signal and idler photons with the idler photon traveling through an interferometer that also allows a photon to exit the interferometer along either arm of the interferometer before reaching the beam splitter where the component wave functions for the idler photon combine.

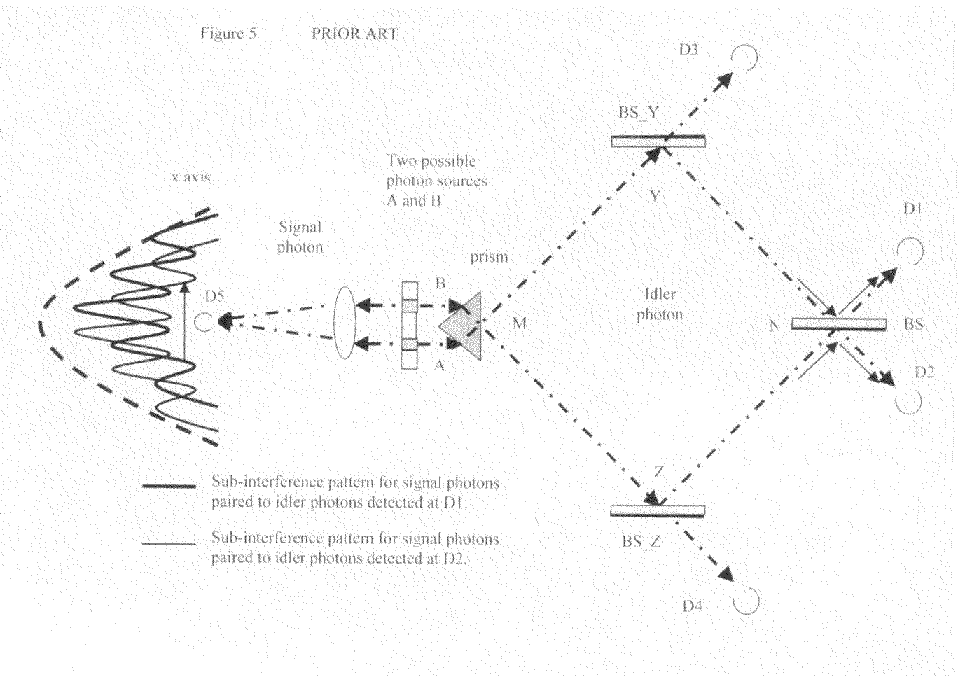

FIG. 6—Overview of basic features of one implementation of Delayed Choice Method with Haunted Quantum Entanglement for Choosing at a Distance an Overall Distribution Exhibiting Either Which-Way Information or Interference that involves alterations to Scully, Englert, and Walther's quantum eraser setup. There is no photodetector. There is a single wall separating the cavities, and there are reservoirs of classical microwave radiation adjacent to each micromaser cavity. The reservoirs are closed off from the cavities and the overall distribution of atoms at the detection screen is the one broad hump characteristic of which-way information concerning the path of the atoms to the detection screen. An rf coil that extends a field over both paths from the exits of the micromaser cavities that places the atom in the state it had before it emitted the photon. The atom passed through only one slit in the double-slit screen, although it is not known through which specific slit the atom passed.

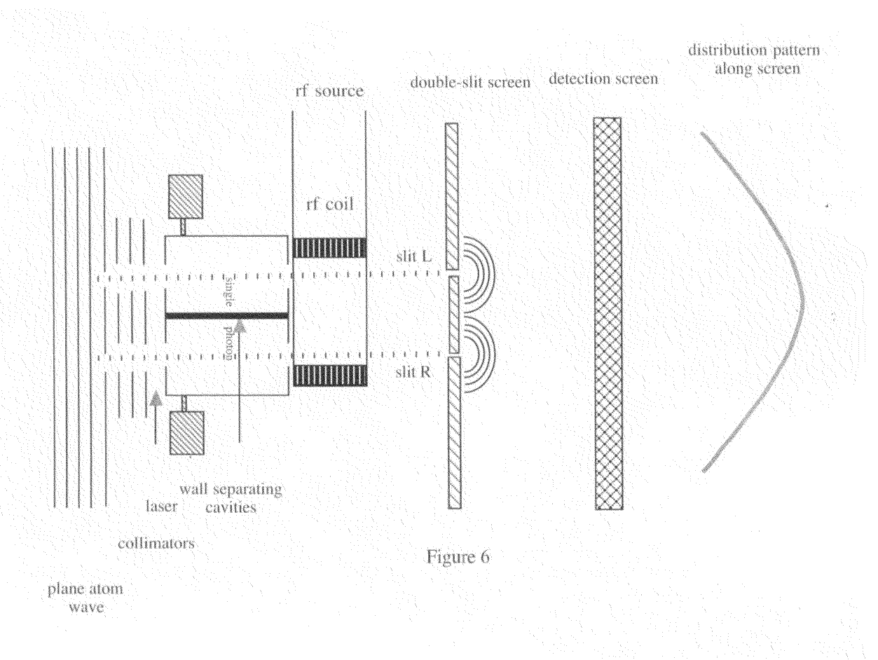

FIG. 7—Changes in the operation of the implementation of Delayed Choice Method with Haunted Quantum Entanglement for Choosing at a Distance an Overall Distribution Exhibiting Either Which-Way Information or Interference that involves alterations to Scully, Englert, and Walther's quantum eraser setup that results in an overall distribution exhibiting interference as if which-way information never existed. The photon is lost by filling both micromaser cavities with classical microwave radiation from the photon reservoirs after the photon is emitted and the atom exits the cavity system and before the atom reaches the two slit screen. An rf coil extends a field over both paths from the exits of the micromaser cavities that places the atom in the state it had before it emitted the photon. Interference is obtained as if the which-way information never existed and the photon never carried the which-way information for the atom that is distant from it. The which-way information carried by the photon is eliminated at a distance from the atom and the entanglement is lost between the atom and the photon.

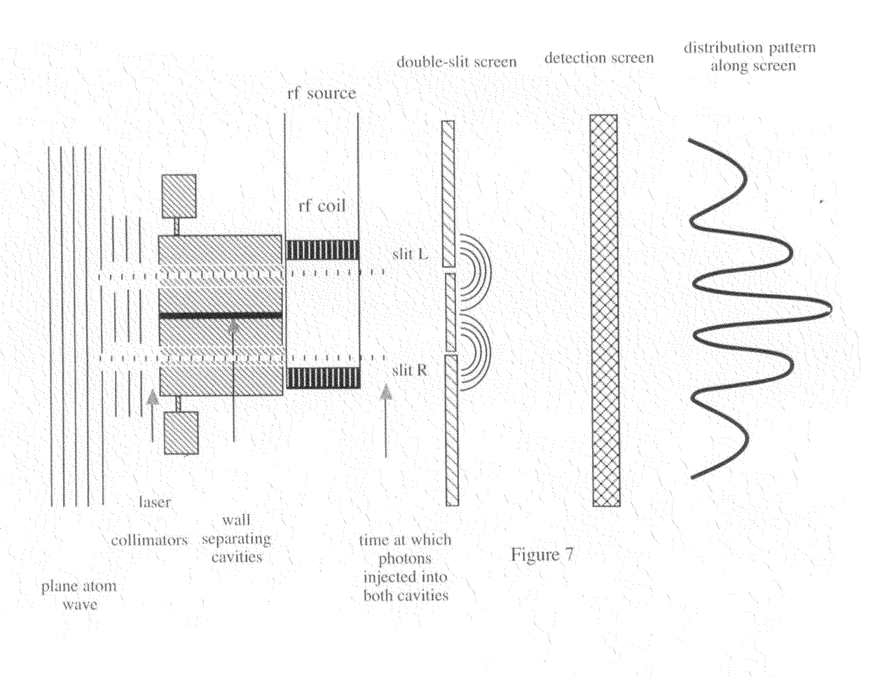

FIG. 8—Overview of basic features of a second implementation of Delayed Choice Method with Haunted Quantum Entanglement for Choosing at a Distance an Overall Distribution Exhibiting Either Which-Way Information or Interference that involves alterations to Kim and his colleague's quantum eraser setup. There are no mirrors and beamsplitter (as well as detectors after the beamsplitter) that allow for an interferometer for the idler photon. The device retains the first legs of the two arms of an interferometer with two possible photon sources over which the idler photons can travel. Photon detectors are located at the end of each arm of the interferometer. (Call this part of the apparatus the idler apparatus.) Except for the two idler photon detectors, the idler apparatus (including the “double-slit” arrangement involved in the generation of the signal-idler photon pairs) is placed in a container that prevents information concerning the state of the idler photons from being available in the environment and anything in the environment from entering the space of the container. This container is evacuated except for the idler photon that traverses it. Another container encompasses the area between the lens that that produces the far field effect for the signal photons until just before the signal photons reach the detector axis. This container is also evacuated except for the signal photon that traverses it. This latter container prevents information concerning the state of the signal photons from being available in the environment and anything in the environment from entering the space of the container. Attached to the container of the idler apparatus are two reservoirs of classical electromagnetic radiation where the component photons are similar in character to the idler photon. Where the reservoirs are closed off from the idler photon apparatus so that none of the classical electromagnetic radiation enters the evacuated idler apparatus, which-way information concerning the idler-signal photon pairs is potentially available as the idler photon traverses one or the other of the paths of the isolated idler apparatus. This which-way information is essentially irreversibly determined when the idler photon is detected at one or the other of two detectors, each detector located at the end of one of the possible paths.

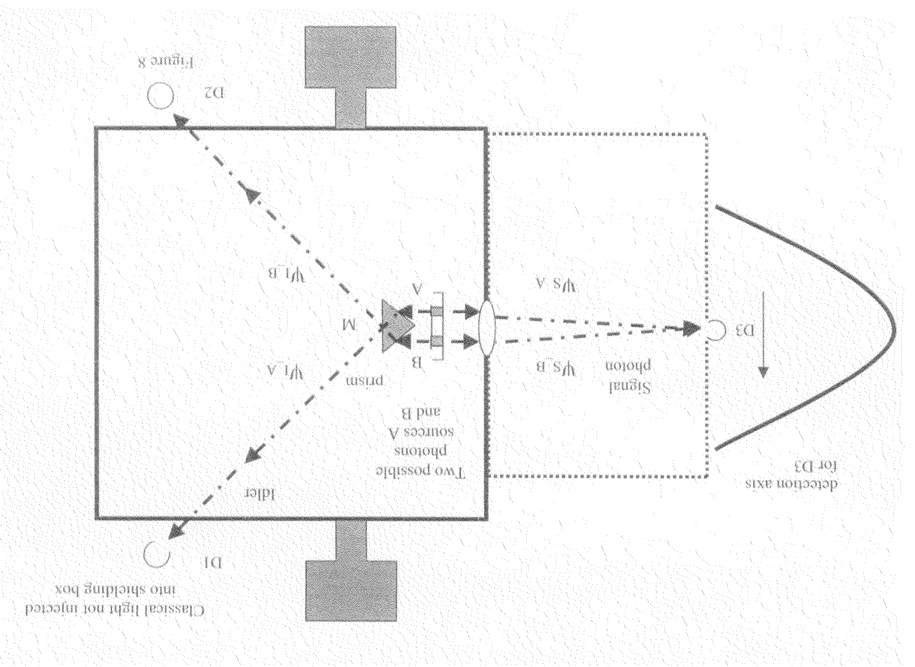

FIG. 9—Changes to the second implementation of Delayed Choice Method with Haunted Quantum Entanglement for Choosing at a Distance an Overall Distribution Exhibiting Either Which-Way Information or Interference that involves alterations to Kim and his colleague's quantum eraser setup. Classical electromagnetic radiation from the reservoirs (where the photons comprising this radiation are similar to the idler photon) is injected into the evacuated idler photon container (except of course for the idler photon) while the idler photon is traversing the container and before the signal photon reaches the axis where it is detected, the overall distribution of the signal photons exhibits interference as if which-way information never existed for the signal photons.

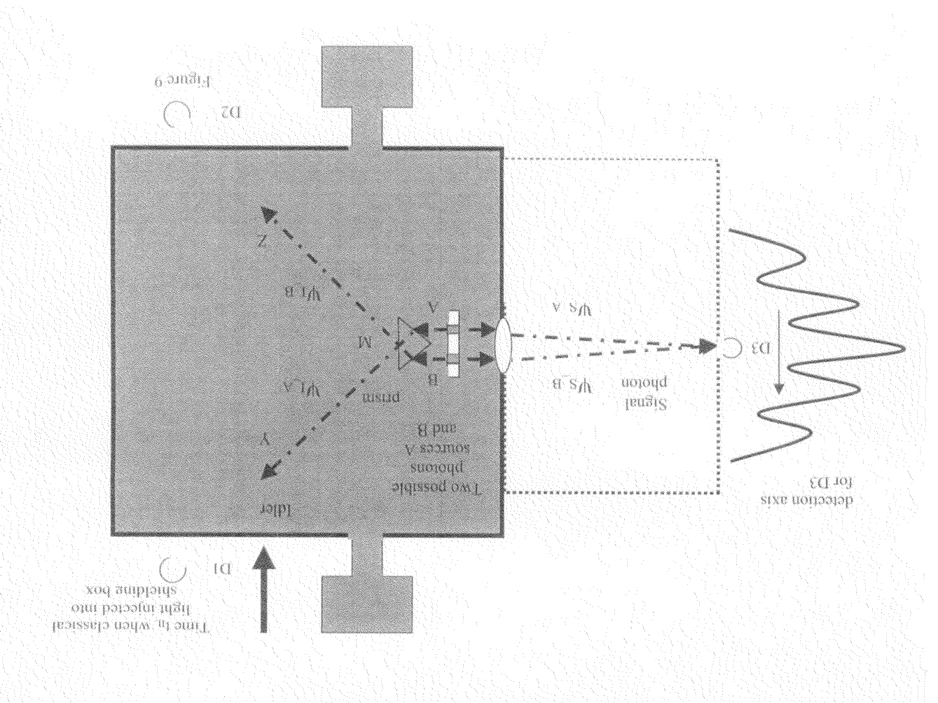

### DETAILED DESCRIPTION OF THE INVENTION

A method is presented wherein there is a delayed choice using haunted quantum entanglement, the consequence of which is that one may choose an overall distribution exhibiting either which-way information or interference for one of the entangled particles that depends on the delayed choice made regarding the other entangled particle that is at a distance.

This method is comprised of the following steps:
1. Entanglement between two particles 1 and 2 where entanglement occurs at one of two possible sites isolated from the environment. Other than which-way information that characterizes the particle pair itself, there is no tell-tale sign of which-way information that remains after the entanglement occurs.
2. Entangled particles physically separate from each other where one particle's motion [1] preserves which-way information that occurred in the entanglement and the other particle's motion [2] supports interference in its own (particle 2's) distribution due to the invention setup. The result is that particle 1 supplies which-way information to particle 2, and this result is the basis for the entanglement of the two particles. The two particles are effectively isolated from the environment as they move away from one another and until just before they are detected.
3. Delayed choice:
Choice A Essentially lose particle 1 that carries which-way information by injecting many other particles of similar character to particle 1 that carries which-way information into a container that heretofore contains only particle 1 and isolates particle 1 from the environment (so that with the injection of many other particles, particle 1 is unrecognizable) while particle 2 is effectively isolated from the environment and before particle 2 is detected or makes available general which-way information held by particle 1 available to the environment. (Particle 1 is essentially lost, particle 1's own which-way information that it supplied to particle 2 is lost, and thus entanglement between particles 1 and 2 that depends on which-way information supplied by particle 1 to particle 2 is also lost.)
Choice B Do not lose particle 1 that carries which-way information by injecting into a container through which particle 1 is traveling many other particles of similar character to particle 1. By not losing particle 1 that carries which-way information, the which-way information carried by particle 1 is not lost. The entanglement is not lost and neither is the which-way information supplied by particle 1 that has supplied which-way information to particle 2. (Particle 1 could travel to and be detected at a detector that is associated with the specific path of particle 1 that would provide a final result regarding which path particle 1 took.)
3. Depending on Choice A or Choice B:
If Choice A Repeat runs of invention with choice A 100 times consecutively to develop an overall interference distribution pattern for particle 2.
If Choice B Repeat runs of invention with choice B 100 times consecutively to develop an overall which-way distribution pattern for particle 2.
   Regarding the method of Delayed Choice Method with Haunted Quantum Entanglement for Choosing at a Distance an Overall Distribution Exhibiting Either Which-Way Information or Interference, the following points should be noted:
1) The process of entanglement is isolated and the resulting entangled particles are each isolated in their subsequent motion until the particle carrying the which-way information (particle 1) is: 1) either lost through the injection of many particles into the container with particle 1 that are similar in character to particle 1, with the accompanying loss of the entanglement or 2) there is no injection of many particles of a similar character to particle 1 into the container with particle 1 and particle 1 is detected at one of its detectors (either detector 1 or detector 2) (providing which-way information to particle 2).
2) Even though each particle originally possesses which-way info, one particle (particle 2) cannot access its own which-way info after entanglement due to the device setup. After entanglement, the device setup supports interference rather than which-way information for particle 2 (e.g., an entangled pair created at one of two “slits” and then the separation between the two “slits” as well as the width of each slit acts as a double slit setup for particle 2 with the result that one obtains interference for particle 2 in the absence of which-way information from particle 1.) The which-way info for particle 2 can come from particle 1 where the which-way info is preserved for particle 1 unless and until the particle carrying the which-way information is lost through the injection of many particles into container with particle 1 that are similar in character to particle 1.

One non-limiting implementation of the invention (implementation 1) consists of the following elements and operates in the following way:
1. A micromaser cavity system consisting of two micromaser cavities separated by a common wall that allows for an atom passing through the cavity system to emit a photon into the cavity system without affecting the motion of the atom that emits the photon. The system must be constructed so that the specific cavity into which the photon was deposited is not known.
   The micromaser cavities need to be constructed so that the atom passing through the cavity system will emit a photon with a probability of 1. Rydberg states of rubidium can be used, specifically the transition from 63 p_{3/2} to 61 d_{5/2} as the atom passes through the micromaser cavity system and spontaneously emits a photon. The resonant micromaser cavities each operate at about 21 GHz and do not contain any photons before the photon is emitted by the rubidium passing through. Rydberg states of other kinds of atoms besides rubidium can be used in conjunction with suitably adjusted resonant micromaser cavities such that the excited atom does not emit a photon until it enters the micromaser cavity system where it has a probability of one of spontaneously emitting a photon in one or the other of the micromaser cavities.
2. A source of atoms that ejects atoms toward the micromaser cavity system such that the atom has an equal chance of passing through either micromaser cavity with the shutter closed when the atom passes through. The type of atom selected and the type of micromaser cavity selected must be such that when the atom is excited it must not emit a photon until the atom enters the micromaser cavity system and inside the micromaser cavity system it emits a photon with a probability of one. The choice of micromaser and atom must be such that the emission of a photon by the atom in the micromaser cavity system must not alter the motion of the atom in any significant manner.
3. A set of collimators between the atom source and the micromaser cavity system.
4. A suitable laser placed just before the micromaser cavity system that stimulates the atom where this stimulation allows the atom to then emit a photon in the micromaser cavity system. For example, the laser excites the rubidium to a Rydberg state such as 63 p_{3/2 .}
5. An rf coil that extends a field over both paths, with the field beginning at the exits of the micromaser cavities, that places the atom in the state it had before it emitted the photon.
6. A double slit screen where each slit is associated in a one-to-one fashion with one of the micromaser cavities such that an atom exiting one of the micromaser cavities will pass through its associated slit in the double-slit screen in the absence of an event involving the injection of classical microwave radiation into both micromaser cavities after the atom has exited the micromaser cavity system and before the atom reaches the double-slit screen.
   The dimensions of the double-slit allow for the development of interference in the distribution of the signal photons similar to a two-slit interference pattern. Which-way information carried by the signal photon, rooted in the specific “slit” at which it originated, is lost.
7. Two containers containing classical electromagnetic radiation composed of photons similar in character to the emitted photon and which isolate the classical electromagnetic radiation from the environment. The containers are on opposite walls of the micromaser cavities (one container per cavity). Each container with the classical electromagnetic radiation is separated from its associated micromaser cavity by a barrier. These barriers can be opened which allows the classical electromagnetic radiation to enter its associated micromaser cavity after the atom exits the cavity system and before the atom reaches the two slit screen.
8. An atom detector where the spatial distribution of the atoms over a set of runs can be recorded.
9. Delayed choice:
Choice A Essentially lose the emitted photon that carries which-way information by injecting many other photons of similar character to the emitted photon that carries which-way information (so that with the injection of many photons of similar character, the emitted photon is unrecognizable) while the atom is effectively isolated from the environment and before the atom reaches the two slit arrangement. This event is accomplished by opening the barriers separating the containers of classical electromagnetic radiation (where the photons are similar in character to the emitted photon) from their associated micromaser cavities simultaneously before the atom reaches the two slit arrangement. (The emitted photon is essentially lost in the classical electromagnetic radiation, its which-way information that it supplied to the atom that emitted the photon is lost, and thus entanglement is also lost and as well as the which-way information supplied by the emitted photon to the entangled atom that emitted the photon.)
Choice B Do not lose the emitted photon that carries which-way information. The entanglement is not lost and neither is the which-way information supplied by the emitted photon that has supplied which-way information to the entangled atom that emitted the photon.
Depending on Choice A or Choice B:
If Choice A Repeat runs of invention with choice A 100 times consecutively to develop an overall interference distribution pattern for the atoms that emit the photons.
If Choice B Repeat runs of invention with choice B 100 times consecutively to develop an overall which-way distribution pattern for the atoms that emit the photons.
   Regarding implementation 1 of Delayed Choice Method with Haunted Quantum Entanglement for Choosing at a Distance an Overall Distribution Exhibiting Either Which-Way Information or Interference, the following points should be noted:
1) Even though each member of the entangled pair (i.e., the emitting atom and the emitted photon) originally possesses which-way information, the atom cannot access its own which-way information after the atom passes through the two slit arrangement. After entanglement and the atom passes through the two slit arrangement, the invention setup supports interference rather than which-way information for the atom because the separation between the two slits as well as the width of each slit in the two slit arrangement results in interference for the atom in the absence of which-way information from the photon emitted in the micromaser cavity system. The which-way information for the emitting atom can come from the emitted photon where the which-way information is preserved for the emitted photon through not injecting classical electromagnetic radiation into the micromaser cavities after the atom exits the cavity system and before the atom reaches the two slit arrangement.

A second non-limiting implementation of the invention (implementation 2) consists of the following elements and operates in the following way:
1. A process for creating photon pairs (signal and idler photon pairs) at one of two “slits”. One example of such a process is spontaneous parametric down conversion (SPDC) where after splitting the pump laser beam with a double slit these two resulting beams interact with a non-linear optical crystal. These two possible interaction areas in the non-linear optical crystal are the two possible sources of the signal-idler photon pair. A specific example is given by Kim and his colleagues (Kim et al. Phys. Rev. Lett., 84, 1-5, 1999) where a 351.1 nm Argon ion pump laser beam was used, and this beam was sent through a double slit, and then interacted with a “type-II phase matching non-linear optical crystal BBO (β-BaB₂O₄).” The slits were each 0.3 micromaser wide and the distance between the center of the two slits was 0.7 micromaser. The result of Kim and his colleagues' method were pairs of 702.2 nm orthogonally polarized signal-idler photons generated at different regions of the non-linear optical crystal. These different regions where the signal-idler photon pairs were generated (“slits”) correspond to the different photon sources. The paired signal and idler photons travel away from each other in different directions where each photon in the pair has its own set of two possible linear and parallel paths.
2. Linear and parallel paths of equal length from the two “slits” that the signal photon can travel on its path to a detector, and possibly a lens in the linear and parallel paths of the signal photon after the double slit to produce the far field effect.
3. Linear and parallel paths of equal length from the two “slits” that the idler photon can travel to a Glen-Thompson prism (used by Kim and his colleagues), or equivalent instrument, where the linear and parallel paths enter, are refracted, and intersect where they exit the prism. There is no other distinction other than the photon source-path to prism association that allows for distinguishing a photon traveling from its specific source to the prism from a photon that travels from the other specific source to the prism.
4. The “front end” of an interferometer where there are two linear paths of equal length for the idler photon with each path originating at the intersection of the two paths for the photon exiting the prism and where the paths diverge (similar to the first leg of a Mach-Zender interferometer) and end at a photon detector. The idler photon travels along one of these paths at least initially. Which-way information carried by the signal photon rooted in the specific “slit” at which it originated is preserved and can be used to provide which-way information for the signal photon with which the idler photon is entangled.
5. A photon detector located at the end of each of the idler photon paths just outside the idler photon container.
6. The dimensions of the double-slit relative to the wavelength of the paired signal photon are the same as in the Kim experiment and allow for the development of interference in the distribution of the signal photons similar to a two-slit interference pattern. Which-way information carried by the signal photon rooted in the specific “slit” at which it originated is lost.
7. A detection device that can detect signal photons along an axis roughly perpendicular to path/s of the signal photon. One instantiation of this detection device could be that of Kim and his colleagues who used a detector that can move along an axis roughly perpendicular to the path/s of the signal photon. This detector scanned the noted axis with a step motor. Where a lens is used to produce the far field effect closer to the two possible photon sources, the detector is placed along the lens' Fourier transform plane.
8. A container containing only the idler photon, as well as the signal photon until it enters its own container, that isolates the idler photon, and the signal photon while it is in the idler photon's container, from the environment as the idler photon and the signal photon travel from their origin at one of the two “slits” until just before the idler photon could be detected along one of its possible paths, and until the signal photon enters its own container.
9. A second container containing only the signal photon that isolates the signal photon from the environment as the signal photon travels from the idler photon's container until just before the signal photon is detected.
10. Two containers containing classical electromagnetic radiation composed of photons similar in character to the idler photon and which isolate the classical electromagnetic radiation from the environment. The containers containing electromagnetic radiation are on opposite walls of the evacuated container that isolates the idler photon from the environment as it travels from its origin at one of the two “slits” until just before the idler photon is detected along one of its possible paths. Each container containing classical electromagnetic radiation is separated from the idler photon's container by a barrier. This barrier can be opened which allows the classical electromagnetic radiation to enter into the idler photon's container as the idler photon travels through its container.
11. A photon counter that tallies the number of idler photons detected at each of the photodetectors, on the exit paths from the interferometer, over a set of runs (of perhaps 100) using choice B of photons through the interferometer where classically microwave radiation where the component photons are of a similar character to the idler photon is not introduced while the idler photon is traversing through its container on the way to one or the other of the detectors.
12. A pattern detector that determines whether the distribution pattern of signal photons in a set of runs (of perhaps 100) using choice A is the one wide hill pattern characteristic of the general availability of which-way information (concerning the idler photons) or instead is the many narrow hills pattern characteristic of interference (concerning the idler photons) where each set of runs is conducted either: 1) with the injection of classical microwave radiation while the idler photon is traversing through its container, or 2) where classical microwave radiation is not introduced while the idler photon is traversing through its container.
13. Delayed choice:
Choice A Essentially lose the idler photon that carries which-way information by injecting many other photons of similar character to the idler photon that carries which-way information (so that with the injection of many photons of similar character the idler photon, the idler photon is unrecognizable) while the signal photon is effectively isolated from the environment and before the signal photon is detected and before which-way information for the idler photon becomes available to the environment or an irreversible which-way measurement is made on the idler photon. (The idler photon is essentially lost, its which-way information that it supplied to the signal photon is lost, and thus entanglement is also lost as well as the which-way information supplied by the idler photon to the entangled signal photon.)
Choice B Do not lose the idler photon that carries which-way information. The entanglement is not lost and neither is the which-way information supplied by the idler photon that has supplied which-way information to the entangled signal photon. (The idler photon could travel to a detector that is associated with the specific path of the idler photon that would provide a final result regarding which path the idler photon took.)
Depending on Choice A or Choice B:
If Choice A Repeat runs of invention with choice A 100 times consecutively to develop an overall interference distribution pattern for the signal photons.
If Choice B Repeat runs of invention with choice B 100 times consecutively to develop an overall which-way distribution pattern for the signal photons.
   Regarding the method of Delayed Choice Method with Haunted Quantum Entanglement for Choosing at a Distance an Overall Distribution Exhibiting Either Which-Way Information or Interference, the following points should be noted:
1) The process of entanglement is isolated and the resulting entangled signal photon and idler photon are each isolated in their subsequent motion until the particle carrying the which-way information (the idler photon) is: 1) either lost through the injection of many particles into container with the idler photon that are similar in character to the idler photon, with the accompanying loss of the entanglement or 2) there is no injection of many particles of a similar character to the idler photon into the container with the idler photon, and the idler photon could be detected at one of its detectors (either detector 1 or detector 2) (providing which-way information to the signal photon).
2) Even though each photon originally possesses which-way information, one photon (the entangled signal photon) cannot access its own which-way information after entanglement due to the device setup. After entanglement, the device setup supports interference rather than which-way information for particle 2 (e.g., an entangled pair created at one of two “slits” where the separation between the two “slits” as well as the width of each slit acts as part of a double slit setup for the entangled signal photon with the result that one obtains interference for the signal photon in the absence of which-way information from the idler photon). The which-way information for the signal photon can come from the idler photon where the which-way information is preserved for the idler photon (since for example the idler photon has a distinct path with each distinct path associated with one of the “slits” where the signal-idler photon entanglement occurs) unless and until the idler photon which carries the which-way information is lost through the injection of many particles into the idler photon's container that are similar in character to the idler photon while the idler photon traveling through its container.

I claim:

1. A method using delayed choice with haunted quantum entanglement for choosing either a which-way or interference distribution at a distance, comprising the following steps:
a. entanglement between two particles 1 and 2 where the entanglement occurs at one of two possible sites isolated from the environment, and other than which-way information that characterizes the particle pair itself, there is no other tell-tale sign of which-way information in the entanglement process that remains after the entanglement occurs,
b. the entangled particles physically separate from each other where one particle's motion [particle 1] preserves which-way information that accompanied the entanglement and the other particle's motion [particle 2] supports interference in particle 2's own distribution with the result that particle 1 supplies which-way information to particle 2, and the two particles are effectively isolated from the environment as they move away from one another and remain effectively isolated from the environment until just before they are detected,
c. there is a delayed choice wherein in choice A particle 1 that carries which-way information becomes unrecognizable and essentially lost by injecting many other particles of similar character to particle 1 that carries which-way information while particle 2 is effectively isolated from the environment and before particle 2 is detected or makes available general which-way information held by particle 1 available to the environment and before which-way information for 1 becomes available to the environment or an irreversible which-way measurement is made on 1, or in choice B wherein many other particles of similar character to particle 1 that carries which-way information are not injected, and particle 1 that carries which-way information and that supplies which-way information to particle 2 is not lost,
d. depending on choice A or choice B:
if choice A—repeat runs with choice A 100 times consecutively to develop an overall interference distribution pattern for particle 2,
if choice B—repeat runs with choice B 100 times consecutively to develop an overall which-way distribution pattern for particle 2,
whereby either an overall distribution of an entity exhibiting interference or instead exhibiting which-way information can be developed depending on a choice made distant from the site of the distribution.

2. A non-limiting implementation of the method described in claim 1 using delayed choice with haunted quantum entanglement for choosing either a which-way or interference distribution at a distance, relying on:
a. an atom source,
b. a micromaser cavity system of two adjoining micromaser cavities through which atoms from the atom source pass one at a time and wherein the micromaser cavities are each resonant and operate at the same frequency with this frequency suitable for unit probability that each of the atoms passing through the micromaser cavity system spontaneously emits a photon into one or the other of the micromaser cavities such that there is a 50-50 chance that the emitted photon is emitted into either of the micromaser cavities,
c. a laser situated before the entrance to the micromaser cavity system that excites each of the atoms to a specified state such that each atom will emit a photon in the micromaser cavity system as the atom passes through the micromaser cavity system,
d. an rf coil that extends a field over both paths, with the field beginning at the exits of the micromaser cavities, that places the atom in the state it had before it emitted the photon,
e. a double-slit screen located after the exit of the micromaser cavity system and located on the path of each atom exiting the micromaser cavity system such that there exists a one-to-one correspondence between each micromaser cavity and one of the slits in the double-slit screen such that the atom exiting one of the micromaser cavities will pass through the micromaser cavity's associated slit in the double-slit screen unless the emitted photon is lost,
f. an atom detector wherein the spatial distribution of the atoms passing through the micromaser cavity system and the double-slit screen over a set of runs is determined,
g. two containers containing classical electromagnetic radiation composed of photons similar in character to the emitted photon and which isolate the classical electromagnetic radiation from the environment. The containers are on opposite walls of the micromaser cavities, one container per cavity. Each container with the classical electromagnetic radiation is separated from its associated micromaser cavity by a barrier. These barriers can be opened which allows the classical electromagnetic radiation to enter its associated micromaser cavity after the atom exits the micromaser cavity system and before the atom reaches the two slit screen,
and which implements the method in the following way:
h. there is a delayed choice wherein, in choice A the emitted photon that carries which-way information becomes unrecognizable and essentially lost by injecting many other photons of similar character to the photon that carries which-way information into both of the micromaser cavities that could have the emitted photon, the cavity containing emitted photon prior to this injection containing only the emitted photon and the other cavity having no photons, prior to the emitting atom reaching the double slit screen and making available general which-way information held by the emitted photon, the result being that the emitted photon's own which-way information that it supplied to the emitting atom is lost with the essential loss of the emitted photon, and thus entanglement between the emitting atom and emitted photon is also lost since the emitted photon cannot supply which-way information to the emitting atom, or in choice B wherein many other photons of similar character to the emitted photon that carries which-way information are not injected, and the emitted photon that carries which-way information and that supplies which-way information to the emitting atom is not lost,
i. depending on choice A or choice B:
if choice A—repeat runs with choice A 100 times consecutively to develop an overall interference distribution pattern for the emitting atoms,
if choice B—repeat runs with choice B 100 times consecutively to develop an overall which-way distribution pattern for the emitting atoms,
whereby either an overall distribution of the emitting atoms exhibiting interference or instead exhibiting which-way information can be developed depending on a choice made distant from the site of the distribution of the emitting atoms, this distant site being where the micromaser cavities holding the emitted photon are located.

3. A non-limiting implementation of the method described in claim 1 using delayed choice with haunted quantum entanglement for choosing either a which-way or interference distribution at a distance, relying on:
a. a process for creating photon pairs, such as signal and idler photon pairs such as spontaneous parametric down conversion, SPDC, where after splitting the pump laser beam with a double slit these two resulting beams interact with a non-linear optical crystal and these two possible interaction areas in the non-linear optical crystal are two possible sources of the signal-idler photon pairs and where these different and distinct areas where the signal-idler photon pairs were generated correspond to two slits where the paired signal and idler photons travel away from each other in different directions where each photon in the pair has its own set of two possible linear and parallel paths,
b. linear and parallel paths of equal length from the two slits that the signal photon can travel on its path to a detector, and possibly a lens in the linear and parallel paths of the signal photon after the double slit that can produce the far field effect closer to the two possible photon sources,
c. linear and parallel paths of equal length from the two slits that the idler photon can travel to a Glen-Thompson prism, or equivalent instrument, where the linear and parallel paths enter, are refracted, and intersect where they exit the prism, and there is no other distinction other than the association between the photon source and a specific path to the prism that allows for distinguishing a photon traveling from its specific source to the prism from a photon that travels from the other specific source to the prism,
d. the front end of an interferometer where there are two linear paths of equal length for the idler photon with each path originating at the intersection of the two paths for the photon exiting the prism and where the paths diverge, similar to the first legs of a Mach-Zender interferometer, and end at a photon detector, the idler photon travels along one of these paths at least initially, which-way information carried by the idler photon rooted in the specific slit at which it originated is preserved at least initially and can be used to provide which-way information for the signal photon with which the idler photon is entangled,
e. a photon detector located at the end of each of the idler photon paths just outside the idler photon container,
f. the dimensions of the two slits, including the distance between them, relative to the wavelength of the paired signal photon allow for the development of interference in the distribution of the signal photons similar to a two-slit interference pattern, and which-way information carried by the signal photon itself rooted in the specific slit at which it originated is lost,
g. a detector that can detect signal photons along an axis roughly perpendicular to path/s of the signal photon, for example a detector that can move along an axis roughly perpendicular to the path/s of the signal photon, this detector scans the noted axis with a step motor, and where the detector is placed along the lens' Fourier transform plane if a lens is used,
h. a container containing only the idler photon, as well as the signal photon until it enters its own container, that isolates the idler photon, and the signal photon while it is in the idler photon's container, from the environment as the idler photon and the signal photon travel from their origin at one of the two slits until just before the idler photon could be detected along one of its possible paths, and until the signal photon enters its own container,
i. a second container containing only the signal photon that isolates the signal photon from the environment as the signal photon travels from the idler photon's container until just before the signal photon is detected,
j. two containers containing classical electromagnetic radiation composed of photons similar in character to the idler photon and which isolate the classical electromagnetic radiation from the environment, the containers with classical electromagnetic radiation are on opposite walls of the container that isolates from the idler photon from the environment as the idler photon travels from its origin at one of the two slits until just before the idler photon is detected along one of its possible paths, each container with classical electromagnetic radiation is separated from the idler photon's container for the idler photon by a barrier and this barrier can be opened which allows the classical electromagnetic radiation to enter into the idler photon's container as the idler photon travels through its container,
and which implements the method in the following way:
k. there is a delayed choice wherein, in choice A the idler photon that carries which-way information becomes unrecognizable and essentially lost by injecting many other photons of similar character to the idler photon that carries which-way information into the idler photon's container while the signal photon is effectively isolated from the environment and before the signal photon is detected and before any which-way information held by the idler photon is made available to the environment, including by the signal photon that exhibits which-way information furnished by the idler photon until the idler photon is lost, and before an irreversible measurement is made on the idler photon, the result being the idler photon's own which-way information that it supplied to the signal photon is lost with the essential loss of the idler photon, and thus entanglement is also lost since the idler photon can no longer supply which-way information to the signal photon, or in choice B wherein many other photons of similar character to the idler photon that carries which-way information are not injected, and the idler photon that carries which-way information and that supplies the which-way information to the signal photon is not lost,
l. depending on choice A or choice B:
if choice A—repeat runs with choice A 100 times consecutively to develop an overall interference distribution pattern for signal photons,
if choice B—repeat runs with choice B 100 times consecutively to develop an overall which-way distribution pattern for signal photons,
whereby either an overall distribution of the signal photons exhibiting interference or instead exhibiting which-way information can be developed depending on a choice made distant from the site of the distribution of the signal photons, this distant site being where the container holding the idler photons is located.
